(19) United States
(12) Patent Application Publication
(10) Pub. No.: US 2023/0349802 A1
(43) Pub. Date: Nov. 2, 2023

(54) RHEOLOGICAL MEASUREMENT DEVICE WITH OPTICAL DATA TRANSFER

(71) Applicant: AMETEK, INC., Berwyn, PA (US)

(72) Inventors: Alex H. Mak, Canton, MA (US); John Rubis, East Falmouth, MA (US); Marian Steinert, Dresden (DE); James A. Salomon, Providence, RI (US)

(73) Assignee: AMETEK, INC., Berwyn, PA (US)

(21) Appl. No.: 18/140,503

(22) Filed: Apr. 27, 2023

Related U.S. Application Data
(60) Provisional application No. 63/336,737, filed on Apr. 29, 2022.

(51) Int. Cl. G01N 11/14

(52) U.S. Cl. CPC G01N 11/14

(57) ABSTRACT

A rheological measurement method and device (e.g., a viscometer or rheometer) for measuring rheological properties are disclosed. A rheological property such as viscosity is determined by detecting data corresponding to torque between a drive shaft and a measurement shaft, producing an optical signal corresponding to the detected data, sending the corresponding optical signal with an optical transmitter supported by a rotational structure coupled to the drive shaft, receiving the optical signal from the optical transmitter with an optical receiver supported by a stationary structure of the rheological measurement device, producing an electrical signal corresponding to the received optical signal, and generating a measurement signal based on the electrical signal that corresponds to the torque between the drive shaft and the measurement shaft.

### CROSS-REFERENCE TO RELATED APPLICATIONS

This application claims priority to U.S. Provisional Application Ser. No. 63/336,737 filed on Apr. 29, 2022, the contents of which are incorporated fully herein by reference.

### TECHNICAL FIELD

The present subject matter relates to rheological measurement devices.

### BACKGROUND

Rheological measurement devices such as rheometers and viscometers measure rheological properties of a material (e.g., a liquid, suspension, or slurry). A viscometer typically measures the viscosity of a material. A rheometer typically measures other rheological properties (e.g., yield, creep, elasticity, etc.) in addition to or instead of viscosity.

### BRIEF DESCRIPTION OF THE DRAWINGS

The drawing figures depict one or more implementations, by way of example only, not by way of limitations. In the figures, like reference numerals refer to the same or similar elements. Features of the various implementations disclosed will be readily understood from the following detailed description, in which reference is made to the appended drawing figures. A reference numeral is used with each element in the description and throughout the several views of the drawing. When a plurality of similar elements is present, a single reference numeral may be assigned to like elements, with an added letter referring to a specific element.

The various elements shown in the figures are not drawn to scale unless otherwise indicated. The dimensions of the various elements may be enlarged or reduced in the interest of clarity. The several figures depict one or more implementations and are presented by way of example only and should not be construed as limiting. Included in the drawing are the following figures:

FIG. 1A is a perspective view of a rheological measurement device;

FIG. 1B is a cutaway side view internal components of the rheological measurement device for driving a spindle within a material and detecting a rheological parameter of the material.

FIG. 2 is a block diagram partially in circuit diagram form illustrating aspects of wireless power transmission and data flow within the rheological measurement device.

FIG. 3A is a circuit diagram of a resonant converter for use within the rheological measurement device.

FIG. 3B is an illustration of a coil for use in the resonant converter of FIG. 3A and the wireless power receiving circuit of FIG. 3C.

FIG. 3C is a circuit diagram of a wireless power receiving circuit for use within the rheological measurement device.

FIG. 4A is a circuit diagram of an optical data link transmitter for transferring data within the rheological measurement device.

FIG. 4B is an image of a circuit board with a superimposed diode pair branch layout pattern.

FIG. 4C is a circuit diagram of an optical data link receiver for transferring data within the rheological measurement device.

FIG. 5 is a circuit diagram of an angular displacement sensing circuit of an angular transducer circuit within the rheological measurement device.

FIG. 6A is a block diagram illustrating the layout of transducer coils on a printed circuit board for use in the transducer of the rheological measurement device.

FIG. 6B is an illustration of a spoiler coil for use in the transducer of FIG. 6A.

FIGS. 7A, 7B, 7C, 7D, 7E, and 7F block diagrams partially in circuit diagram form of alternative transducer examples of use in the transducer of the rheological measurement device.

FIG. 8 is an illustration of level sensor for use with the rheological measurement device.

FIGS. 9A, 9B, and 9C are flow charts of example processes performed by the rheological measurement device.

### DETAILED DESCRIPTION

Rheological measurement methods and devices (e.g., viscometers/rheometers) for measuring rheological properties are disclosed. A rheological property such as viscosity is determined by detecting data corresponding to torque between a drive shaft and a measurement shaft, producing an optical signal corresponding to the detected data, sending the corresponding optical signal with an optical transmitter supported by a rotational structure coupled to the drive shaft, receiving the optical signal from the optical transmitter with an optical receiver supported by a stationary structure of the rheological measurement device, producing an electrical signal corresponding to the received optical signal, and generating a measurement signal based on the electrical signal that corresponds to the torque between the drive shaft and the measurement shaft.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

In the following detailed description, numerous specific details are set forth by way of examples to provide a thorough understanding of the relevant teachings. However, it should be apparent to those skilled in the art that the present teachings may be practiced without such details. In other instances, well known methods, procedures, components, and circuitry have been described at a relatively high-level, without detail, to avoid unnecessarily obscuring aspects of the present teachings.

The term “coupled” as used herein refers to any logical, optical, physical, or electrical connection, link or the like by which signals or light produced or supplied by one system element are imparted to another coupled element. Unless described otherwise, coupled elements or devices are not necessarily directly connected to one another and may be separated by intermediate components, elements or communication media that may modify, manipulate, or carry the light or signals.

Reference now is made in detail to the examples illustrated in the accompanying drawings and discussed below.

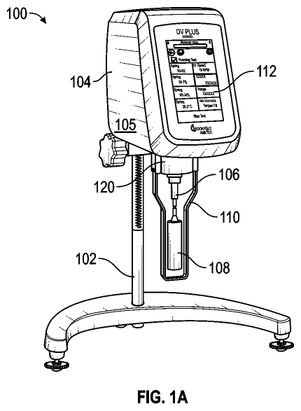

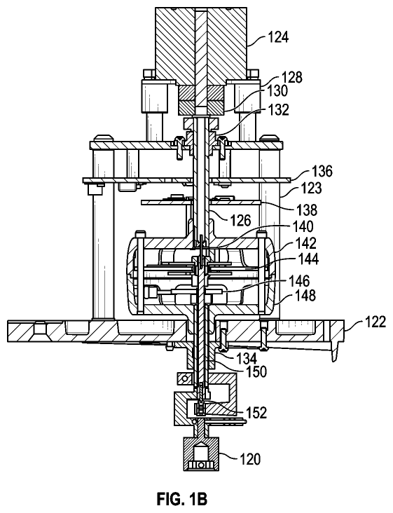

FIG. 1A depicts a rheological measurement device 100 (in the form of a viscometer). The device 100 includes a base 102 and a measurement unit 104 supported by the base 102. The illustrated measurement unit 104 includes components (FIG. 1B) within a housing 105 for rotating a spindle 106 having a measurement head 108. The measurement unit 104 rotates the spindle and, in turn, the measurement head 108 within a material under test to detect torque, which is used to produce rheological properties for the material. A guard 110 may be positioned adjacent the spindle 106 and measurement head 108 to prevent damage to the spindle 106 and measurement head 108. A user interface 112 (e.g., a touch screen display) receives user input and presents the rheological properties.

A spindle coupling 120 extending from a bottom portion of the measurement unit 104 is provided for releasably attaching the spindle 106 to the measurement unit 104. This enables the attachment of different spindles/measurement heads. The coupling may be secured physically (e.g., through the use of mating threads) or magnetically.

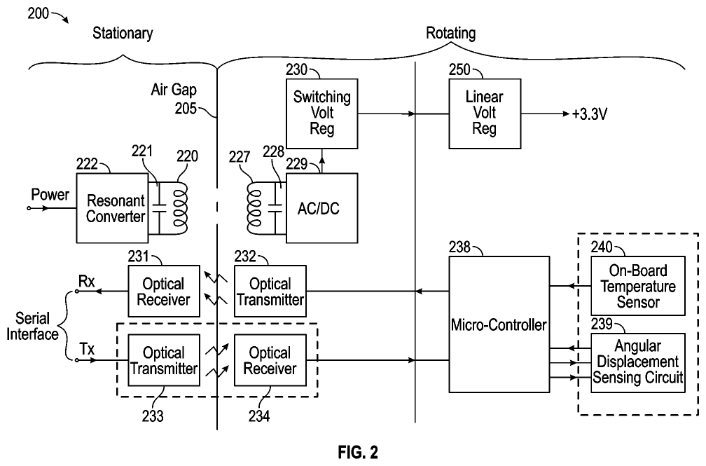

FIG. 2 depicts components contained within a housing 105 of the measurement unit 104 that rotate the spindle coupling 120 and, in turn, the spindle 106 (with measurement head 108) attached thereto. A base plate 122 within the housing provides support for a support structure 123 supporting the components with the measurement unit 104. A stepper motor 124 under control of a microprocessor (not shown) provides rotational force for turning a drive shaft 126.

Motor vibration mounts 128 and a rubber coupler 130 are provided to reduce vibration during use. An upper bushing 132 radially supports an upper portion of the drive shaft 126 and a lower bushing 134 supports a lower portion of the drive shaft 126.

A stationary component 136 is supported by the stationary support structure 123 in a stationary area within the measurement unit 104. As used herein, the terms stationary area/support structures refer to an area(s)/support structure(s) within a rheological measurement device that doesn't move during typical operation of the rheological measurement device. The stationary component 136 includes optical components such as an optical receiver and an optional optical transmitter. The optical receiver and transmitter may be embodied in an optical transceiver. The stationary components may additionally include other components such as a microprocessor for processing signals. In one example, the stationary component is a printed circuit board (PCB) including optical and electrical components.

A rotational component 138 is coupled to the drive shaft 126 in a rotational area with respect to the stationary area when in use. As used herein, the terms rotational area/support structure refers to an area(s)/support structures within a rheological measurement device that moves rotationally during typical operation of the rheological measurement device. The rotational component 138 includes optical components such as an optical transmitter and an optional optical receiver. The optical transmitter and receiver may be embodied in an optical transceiver. The rotational components may additionally include other components such as a microprocessor for processing signals. In one example, the rotational component is a printed circuit board (PCB) including optical and electrical components.

In one example, as shown in FIG. 1B, a measurement shaft 150 is supported by an upper jewel bearing and pin 140 and a lower jewel bearing and pin 152. The measurement shaft 150 is coupled to the drive shaft 126 by a spring 146 (e.g., a spiral spring) within a spring housing 148 that is coupled to a transducer housing 142. The transducer housing 142 houses an angular displacement transducer 144 coupled between the drive shaft 126 and the measurement shaft 150 to detect data corresponding to torque between the drive shaft 126 and the measurement shaft 150. In this example, the angle of displacement corresponds to torque between the drive shaft 126 and the measurement shaft 150.

In one example, the displacement can be determined using a rotary variable differential inductive (RVDI) transducer to measure the angular displacement of the spring wound up. In accordance with this example, the same oscillating circuitry may be used to measure the two coils' inductance with differential response to a given angular displacement to minimize any circuit drift. The transducer outputs may be in the form of frequency and can be measured using a counter with great accuracy. The resulting data is in pure digital form and lends itself to optical data link transmission.

In another example, the displacement can be determined using a rotary variable differential transformer (RVDT) transducer is used to measure the angle of the spring wound up. The analog output gives great resolution. In accordance with this example, the output is digitized before optical transmission.

In another example, the displacement is determined using magnetic components (e.g., on-axis or radial). In an on-axis example, an absolute end-of-shaft magnetic sensor and a dipole magnet may be used to measure the angular displacement of the spring wound up. In accordance with this on-axis example, a similar magnet may be placed in the opposite orientation (away from the sensor path) to counter the earth magnetic field, which may cause torque ripples while rotating.

In another example, the displacement is determined using optical components (e.g., optical radial or optical interrupter). In an optical radial example, an optical sensor in the form of an incremental or absolute encoder may be used to measure the angular displacement of the spring wound up. In an optical interrupter example, relative times between flags or imaging of relationships between a drive shaft marker and a sense shaft marker may be used to measure the angular displacement of the spring wound up.

In another example, not shown, the measurement shaft 150 is coupled to the drive shaft by a twistable element coupled therebetween. In accordance with this example, the transducer may be strain gauge coupled to or integrated into the twistable element. The twistable element may be, by way of nonlimiting example, spring steel, stainless steel, aluminum, beryllium copper, phosphorous bronze, or exotic alloys (e.g., such as found in Rolex watch springs).

In use, the stationary component 136 remains stationary in a stationary area as the stepper motor 124 drives the drive shaft 126. The measurement shaft 150 (a rotational component) is coupled to the drive shaft 126 and rotates in a rotational area with respect to the stationary area. The drive shaft 126 is coupled to the measurement shaft 150 (e.g., via a spring or a twistable element) to impart rotational force. A transducer 144 is coupled between the drive shaft 126 and the measurement shaft 150 to sense an angular offset or force therebetween. The angular offset or force is indicative of torque between the drive shaft 126 and the measurement shaft 150, which corresponds to a rheological property of the fluid such as viscosity. The angular offset/force/torque is optically transferred from the measurement shaft 150 in the rotational area to the stationary component 136 in the stationary area for processing to determine the rheological properties (e.g., for storage in a memory or display on the user interface 112).

FIG. 2 depicts example components of a circuit 200 for wireless power delivery and communication across an air gap 205 between a stationary area and a rotational area.

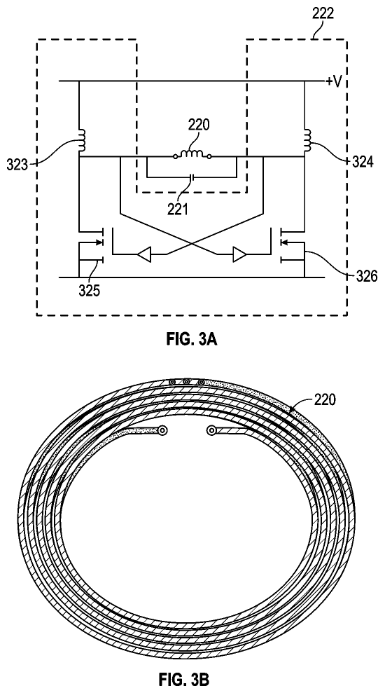

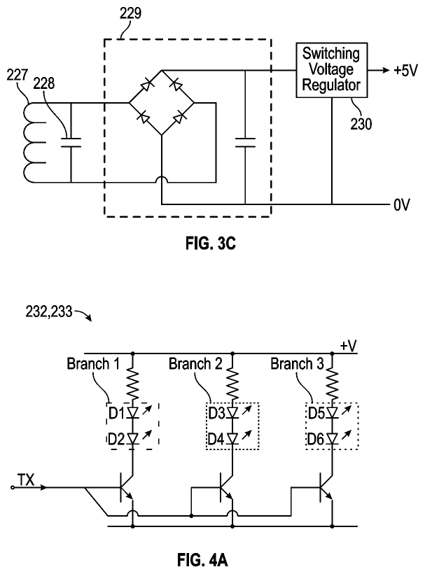

To wirelessly deliver power across an air gap 205, a primary coil 220 is driven by a resonant converter 222 to produce electromagnetic energy. A parallel capacitor 221 is used to adjust the impedance of the primary coil 220 to operate at an optimum frequency and load. Current is fed through a pair of inductors 323 and 324 (FIG. 3A) by switching two transistors 325 and 326 (FIG. 3A) to energize the primary coil (FIG. 3A and 3B). Natural zero-crossing switching may be achieved using the coil voltage directly—resulting in a self-sustained current-fed resonant converter. The primary coil 220, capacitor 221, resonant converter 222, inductors 323/324, and switches 325/326 may be mounted to a printed circuit board (PCB) in the stationary area.

A secondary coil 227 and parallel capacitor 228 (which may be similar or identical to the primary coil 220 and parallel capacitor 221) receives the electromagnetic energy produced by the primary coil 220. A bridge rectifier and smoothing capacitor 229 such as depicted in FIG. 3C rectifies and smooths alternating current (AC) power. A switching voltage regulator 230 regulates the power to a desired voltage (e.g., positive 5 volts) for providing power to the components in the rotational area. The secondary coil 227, capacitor 228, bridge rectifier and smoothing capacitor 229, and switching voltage regulator 230 may be mounted to another PCB in the rotational area.

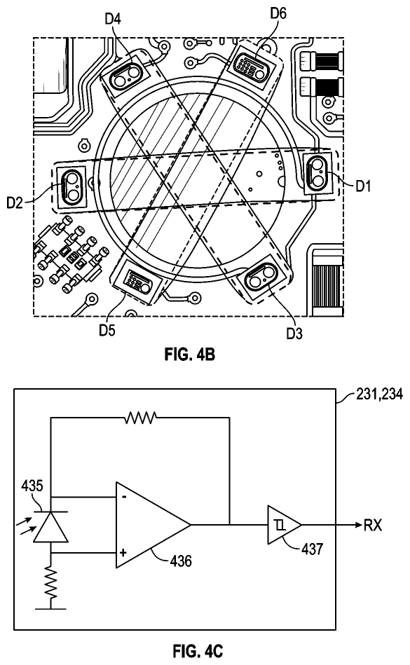

An optical transmitter 232, such as shown in FIG. 4A, transmits data (e.g., transducer data) from the rotational area to the stationary area. The illustrated optical transmitter 232 includes six switched light emitting diodes (LEDs). The LEDs are arranged in three branches with two LEDs per branch (branch #1 including LED D1 and LED D2, branch #2 including LED D3 and LED D4, and branch #3 including LED D5 and LED D6). Each pair of LEDs in a branch are laid out in opposite directions from a center point and the branches are equally spaced as illustrated in FIG. 4B to maintain line-of-sight with the photodiode 435 (FIG. 4C) of an optical receiver in the event of a LED or branch failure. The optical transmitter 232 may be mounted to a PCB in the rotational area.

An optical transmitter 233, such as shown in FIG. 4A, may also be present to transmit data (e.g., configuration or firmware updates) from the stationary area to the rotational area. The optical transmitter 233 may be mounted to a PCB in the stationary area.

An optical receiver 231, such as shown in FIG. 4C, receives data (e.g., transducer data) from the rotational area in the stationary area. A photodiode 435 in the stationary area receives optical signals from the optical transmitter 232 in the rotational area and generates a corresponding analogy electrical signal. An amplifier 436 such as a high-speed operational amplifier (op-amp) amplifies the electrical signal and a processing circuit such as a Schmitt trigger 437 produces an associated logic level signal. The optical receiver 231 may be mounted to a PCB in the stationary area. The optical transmitter 233 and the optical receiver 231 may be implemented as an optical transceiver.

An optical receiver 234, such as shown in FIG. 4C, may also be present to receive data in the rotational area (e.g., configuration or firmware updates) from the optical transmitter 233 in the stationary area. The optical receiver 234 may be mounted to a PCB in the rotational area. The optical transmitter 232 and the optical receiver 234 may be implemented as an optical transceiver.

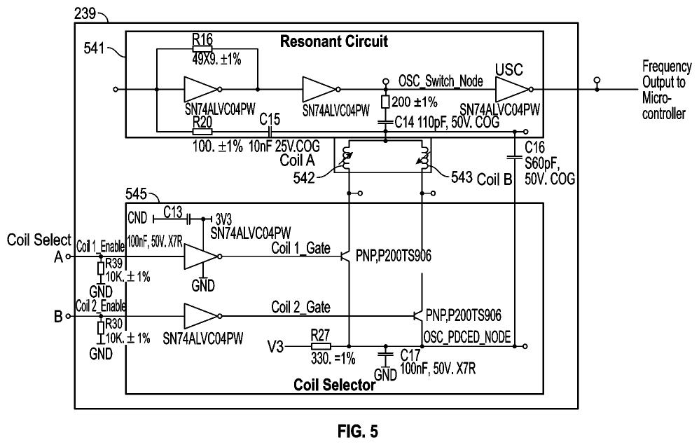

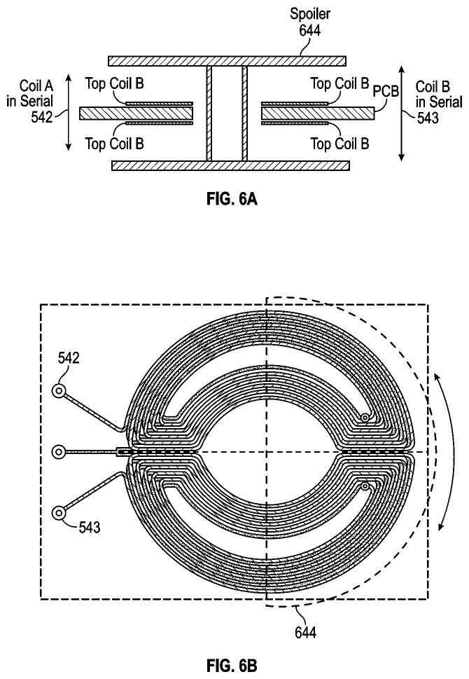

An angular displacement sensing circuit 239 (FIG. 5) senses an angular offset between a drive shaft 126 and a measurement shaft 150. The angular displacement sensing circuit may include a resonant circuit 541, two printed circuit board (PCB) coils 542, 543, a spoiler 644 (FIGS. 6A and 6B), and a coil selector 545. The spoiler 644 angular position changes the coils inductance in a differential manner. The coils 542, 543 are fed to the same resonant circuit 541 to generate a frequency output that is proportional to the coil inductance. The differential frequency measurements reduce the thermal drift effect of the resonant circuit 541 by selecting one coil at a time. In an example, the spoiler 644 operates at +/−37.5 degrees (i.e., 0 degrees to 75 degrees full sale. The spoiler 644 may be made of a conductive material such as aluminum or copper to reduce the coil inductances by covering it due to an Eddy current effect.

The rheological measurement device may include other sensing circuits such as an on-board temperature sensor 240. A microcontroller 238 may receive data from the sensing circuits for optical transmission from the rotational area to the stationary area, e.g., for further processing to determine rheological properties of a material under test. The rotating microcontroller 238 may additionally receive data from the optical receiver in the rotational area, e.g., to selectively activate one or more sensing circuits and to update firmware. Data such as commands sent to the rotating microcontroller may be used to selectively activate mechanical devices to, for example, switch in/out different springs/twistable elements, resulting a single instrument with the ability to measure substantially different torque ranges. Additionally, commands could be sent to, for example, turn on/off normal force control (active cancelation), to heat or cool a sample, etc.

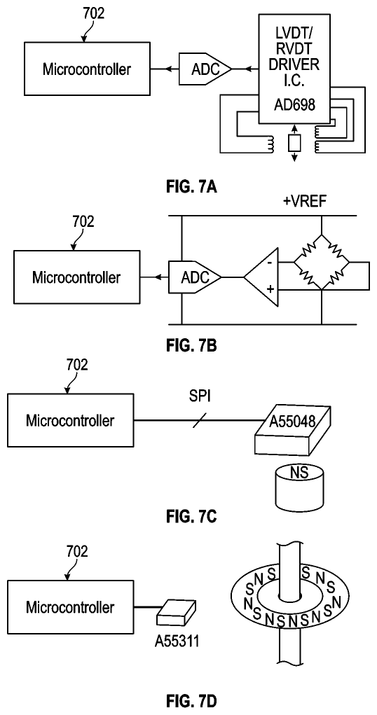

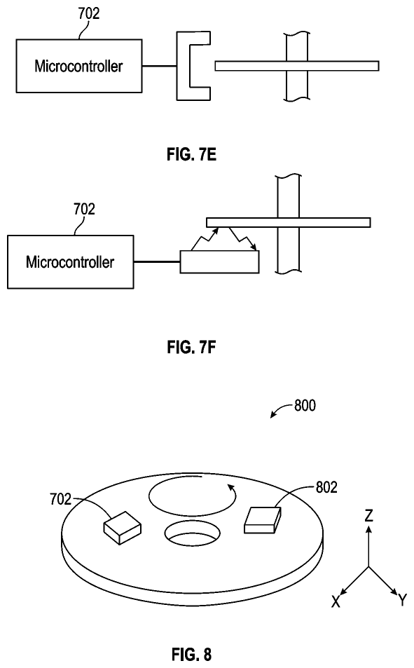

FIGS. 7A, 7B, 7C, 7D, 7E, and 7F are block diagrams depicting alternative transducer examples for use with a microcontroller 702 to detect angular offset or force between a drive shaft 126 and a measurement shaft 150 of a rheological measurement device. FIG. 7A depicts a Linear Variable Differential Transformer (LVDT)/Rotary Variable Differential Transformer (RVDT) sensor. FIG. 7B depicts a strain gauge/torque cell sensor. FIG. 7C depicts an on-axis magnetic sensor. In one example, the on-axis magnetic sensor includes a magnet on an end of the measurement shaft 150 (e.g., at the upper jewel bearing and pin 140) and a magnetic sensor on a PCB in the rotating area adjacent the magnet. FIG. 7D depicts an off-axis magnetic sensor. FIG. 7E depicts a transmissive optical sensor. FIG. 7F depicts a reflective optical sensor.

FIG. 8 is an illustration of level sensor 800 for use with the rheological measurement device to measure whether it is level, e.g., for ensuring an acceptable degree of levelness for sensitive instruments. The level sensor includes a three-dimensional (3D) accelerometer 802 positioned on a surface of a PCB that rotates within the rheological measurement device and provides measurements to a microprocessor 702. In one example, the 3D accelerometer 802 is calibrated to indicate a level condition in a static state. A prior calibration is not necessary if the 3D accelerometer is being rotated and the g-readings in the x and y direction are being monitored. To achieve level condition, adjustment feet are moved up down (automatically/manually) until there are no changes in the x and y g-readings. This avoids the impact of errors in the 3D accelerometer 802 due to thermal, aging, and calibration errors.

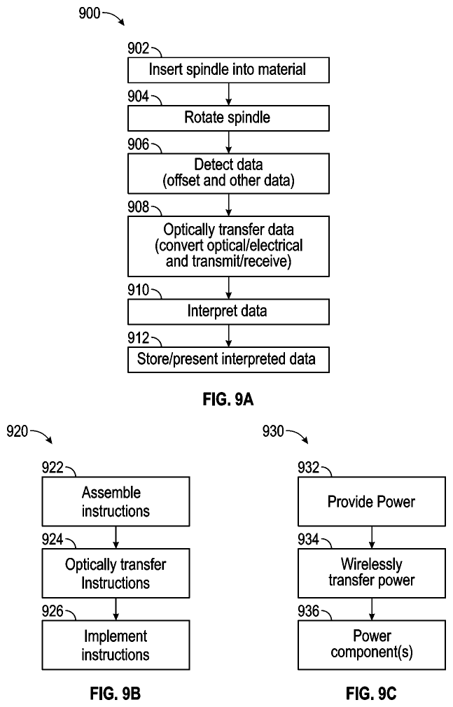

FIGS. 9A, 9B, and 9C are flow charts of example processes performed by the rheological measurement device. The flowcharts may depict the operations as a sequential process, however, many of the operations can be performed in parallel or concurrently. In addition, the order of the operations may be re-arranged. A process is terminated when its operations are completed. A process may correspond to a method, a procedure, etc. The steps of a method may be performed in whole or in part, may be performed in conjunction with some or all of the steps in other methods, and/or may be performed by any number of different systems, such as the systems described in FIGS. 1-8.

FIG. 9A is a flow chart 900 depicting a method for generating rheological measurement data such as viscosity. At block 902, the rheological measurement device inserts a spindle into a material to be tested such that a measurement head on the spindle is fully inserted within the material.

At block 904, the rheological measurement device rotates the spindle. The rheological measurement device may accelerate uniformly from a stop to a desired rotation rate. Additionally, the rheological measurement device may periodically start/stop and may raise/lower the spindle.

At block 906, a measurement sensor such as a transducer obtains measurement data. In one example, a transducer detects data corresponding to torque between a drive shaft 126 and a measurement shaft 150 (coupled to the spindle). In another example, a temperature sensor detects data corresponding to temperature within the rheological measurement device. In another example, a level sensor senses the orientation of the rheological measurement device (e.g., whether it is level).

At block 908, optical components optically transfer data, e.g., from a rotational area to a stationary area. The optical components may receive electrical signals from the measurement sensor(s), convert the electrical signals to optical signals transmitted via LEDs from the rotational area, receive the transmitted optical signals in the stationary area, and convert the received optical signal to electrical signals carrying the data for processing.

At block 910, a processor within the rheological measurement device receives and processes the data in the electrical signals. In one example, the processor of the rheological measurement device identifies viscosity of a material under test by processing data corresponding to torque.

At block 912, the processor within the rheological measurement device stores and presents the processed data. In one example, the processor of the rheological measurement device stores the identified viscosity of the material under test in a memory accessible by the processor. In another example, the processor sends the viscosity to a screen for presentation to a user.

FIG. 9B is a flow chart 920 depicting a method for transferring data generated in a stationary area to a rotational area, e.g., to configure or update measurement sensors. At block 922, a processor (positioned in a stationary area) assembles instructions for configuring or updating measurement sensors in a rotational area. The instructions may include configuration data, firmware updated, or other data.

At block 924, optical components optically transfer data/instructions, e.g., from a stationary area to a rotational area. The optical components may receive electrical signals from a processor, convert the electrical signals to optical signals transmitted via LEDs from the stationary area, receive the transmitted optical signals in the rotational area, and convert the received optical signal to electrical signals carrying the data/instructions for processing.

At block 926, a processor implements the data/instructions in the received instructions. In one example, a processor of a measurement device implements firmware updates for the measurement device. In another example, the processor switches when measurement device are active.

FIG. 9C is a flow chart 930 depicting a method for wireless transferring power from a stationary area of the rheological measurement device to a rotational area, e.g., to power components in the rotational area. At block 932, power is provided in the stationary area. The power may be DC power generated from AC outlet power.

At block 934, the power is wirelessly transferred from the stationary area to the rotational area. In an example, the power is wirelessly transferred as electromagnetic energy between a primary coil in the stationary area to a secondary coil in the rotational area.

At block 936, the wirelessly transferred power is used to power one or more components in the rotational area.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like, whether or not qualified by a term of degree (e.g., approximate, substantially, or about), may vary by as much as ±10% from the recited amount.

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

What is claimed is:

1. A rheological measurement device, comprising:
a drive shaft configured to be driven by a motor,
a measurement shaft coupled to the drive shaft;
a stationary structure;
a rotational structure coupled to the drive shaft;
a transducer configured to detect data corresponding to torque between the drive shaft and the measurement shaft;
an optical transmitter supported by the rotational structure, the optical transmitter configured to produce an optical signal corresponding to the detected data;
an optical receiver supported by the stationary structure, the optical receiver configured to receive the optical signal from the optical transmitter and produce an electrical signal corresponding to the received optical signal;
a first inductive coil coupled to the stationary structure;
a second inductive coil coupled to the rotational structure, the first and second inductive coils positioned relative to each other to transfer power from the first inductive coil to the second inductive coil; and
a processor coupled to the optical receiver, the processor configured to receive the electrical signal and generate a measurement signal based on the electrical signal that corresponds to the torque between the drive shaft and the measurement shaft.

2. The device of claim 1, wherein the transducer is coupled to the rotational structure and the measurement shaft.

3. The device of claim 1, further comprising:
a twistable element coupling the drive shaft to the measurement shaft.

4. The device of claim 3, wherein the transducer comprises a strain gauge integrated into or coupled to the twistable element.

5. The device of claim 1, further comprising:
another optical transmitter supported by the stationary structure, the optical transmitter configured to send another optical signal; and
another optical receiver supported by the rotational structure, the optical receiver configured to receive the other optical signal from the other optical transmitter.

6. The device of claim 1, wherein the transducer comprises at least one of a rotary variable differential inductive (RVDI) transducer or a rotary variable differential transformer (RVDT) transducer.

7. The device of claim 1, wherein the transducer comprises:
an on-axis magnet; and
an additional magnet configured to cancel influence of Earth's magnetic field.

8. The device of claim 1, wherein the stationary structure comprises a first printed circuit board, the rotational structure comprises a second printed circuit board, the optical receiver is mounted on the first printed circuit board, and the optical transmitter is mounted on the second printed circuit board.

9. The device of claim 1, further comprising:
a three-dimensional accelerometer supported by the rotational structure for leveling.

10. A rheological measurement method, comprising:
detecting data corresponding to torque between a drive shaft and a measurement shaft of a rheological measurement device;
producing an optical signal corresponding to the detected data;
sending the corresponding optical signal with an optical transmitter supported by a rotational structure coupled to the drive shaft;
receiving the optical signal from the optical transmitter with an optical receiver supported by a stationary structure of the rheological measurement device;
transferring power between a first inductive coil coupled to the stationary structure and a second inductive coil coupled to the rotational structure;
producing an electrical signal corresponding to the received optical signal; and
generating a measurement signal based on the electrical signal that corresponds to the torque between the drive shaft and the measurement shaft.

11. The method of claim 10, wherein a transducer is coupled to the rotational structure and the measurement shaft to detect the data.

12. The method of claim 10, wherein a twistable element couples the drive shaft to the measurement shaft.

13. The method of claim 12, wherein the data is detected using a strain gauge integrated into or coupled to the twistable element.

14. The method of claim 10, further comprising:
sending another optical signal with another optical transmitter supported by the stationary structure; and,
receiving the other optical signal from the other optical transmitter at an optical receiver supported by the stationary structure.

15. The method of claim 10, wherein the measurement signal is generated by a transducer and wherein the transducer comprises at least one of a rotary variable differential inductive (RVDI) transducer or a rotary variable differential transformer (RVDT) transducer.

16. The method of claim 10, wherein the measurement signal is generated by a transducer and wherein the transducer comprises an on-axis magnet and an additional magnet configured to cancel influence of Earth's magnetic field.

17. The method of claim 10, wherein the stationary structure comprises a first printed circuit board, the rotational structure comprises a second printed circuit board, the optical receiver is mounted on the first printed circuit board, and the optical transmitter is mounted on the second printed circuit board.

18. The method of claim 10, further comprising:
leveling the rheological measurement device using a three-dimensional accelerometer supported by the rotational structure.
